(19) United States
(12) Patent Application Publication
(10) Pub. No.: US 2026/0004759 A1
(43) Pub. Date: Jan. 1, 2026

(54) SYSTEMS AND METHODS FOR ALGORITHMIC GENERATION OF MUSICAL COMPOSITIONS

(71) Applicant: Songbird, Inc., Brooklyn, NY (US)

(72) Inventors: Santiago Danino Beck, Brooklyn, NY (US); Walker Rue Davis, Redondo Beach, CA (US); Juan José Burred, Chatou (FR)

(21) Appl. No.: 19/229,120

(22) Filed: Jun. 5, 2025

Related U.S. Application Data
(63) Continuation-in-part of application No. 18/759,182, filed on Jun. 28, 2024.

(51) Int. Cl. G10H 1/00

(52) U.S. Cl. CPC G10H 1/0025; G10H 2210/056; G10H 2210/111

(57) ABSTRACT

A computer-implemented method for algorithmic generation of musical compositions may include (i) receiving a musical composition and listener preference data associated with at least one listener, (ii) extracting from the musical composition a first set of tracks and a second set of tracks, (iii) generating, by at least one generative machine learning model, based at least in part on the listener preference data, a new set of tracks, and (iv) combining, by a music production model, the first set of tracks extracted from the musical composition with the new set of tracks generated by the generative machine learning model to create a new musical composition based at least in part on the listener preference data. Various other methods, systems, and computer-readable media are also disclosed.

### CROSS-REFERENCE TO RELATED APPLICATIONS

This application is a continuation-in-part and claims the benefit of priority under 35 U.S.C. § 119(e) of U.S. application Ser. No. 18/759,182, filed 28 Jun. 2024, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for algorithmic generation of musical compositions.

FIG. 2 is a flow diagram of an exemplary method for algorithmic generation of musical compositions.

FIG. 3 is a block diagram of an additional exemplary system for algorithmic generation of musical compositions.

FIG. 4 is a block diagram of an additional exemplary system for algorithmic generation of musical compositions.

FIG. 5 is a block diagram of an additional exemplary system for algorithmic generation of musical compositions.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The present disclosure is generally directed to systems and methods for generating novel musical compositions based on the previous works of a composer and/or the preferences of listeners who enjoy that composer's works. In some embodiments, the systems described herein may train a generative machine learning (ML) model on previous partial or complete musical compositions by a composer as well as additional data, such as listening preferences of listeners and/or demographic information pertaining to a given listener base, and may then output new partial or complete musical works for modification and/or publishing by the composer. Additionally, or alternatively, the systems described herein may train an ML model that enables listeners to modify aspects of a composer's musical work in real time while listening to the musical work (e.g., via streaming the musical work from a server) and/or asynchronously for later listening.

In some embodiments, the systems described herein may improve the functioning of a computing device by facilitating the efficient creation of musical compositions, thus lowering the total amount of computing resources (e.g., charge, processor cycles, memory, etc.) used in creating musical compositions. Additionally, the systems described herein may improve the fields of music streaming and/or music composition by enabling composers to more effectively create music tailored to the preferences of listeners.

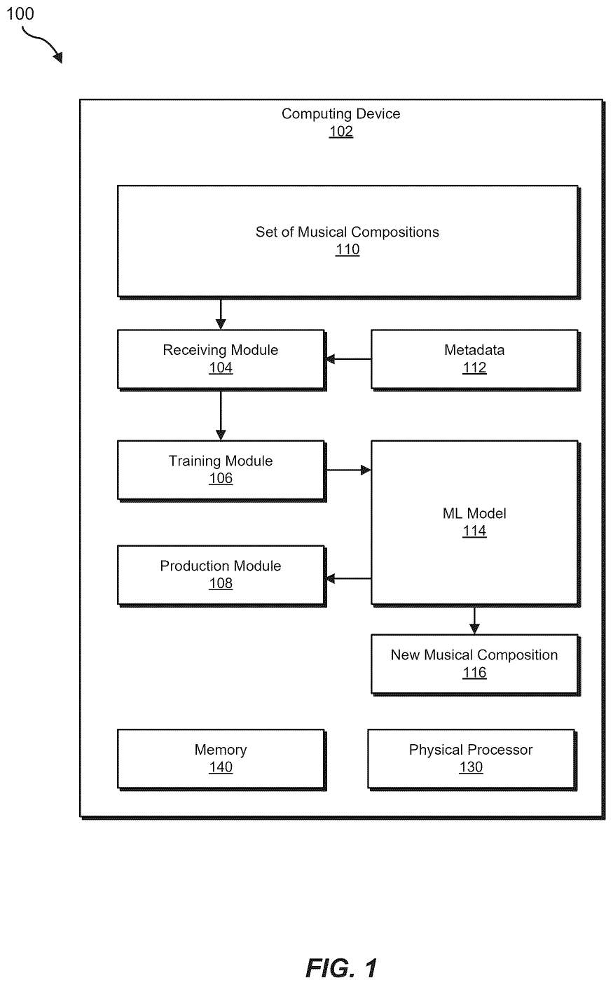

In some embodiments, the systems described herein may algorithmically generate musical compositions while hosted on a computing device. FIG. 1 is a block diagram of an exemplary system 100 for algorithmic generation of musical compositions. In one embodiment, and as will be described in greater detail below, a computing device 102 may be configured with a receiving module 104 that may receive, as a first input set, a set of musical compositions 110 composed by a composer and may also receive, as a second input set, metadata 112 related to at least one musical composition. In some embodiments, receiving module 104 may send this data to a training module 106 that trains a generative ML model 114 on the first input set and the second input set. A production module 108 may produce, by ML model 114, a new musical composition 116.

Computing device 102 generally represents any type or form of computing device capable of reading computer-executable instructions. For example, computing device 102 may represent a personal computing device. Additional examples of computing device 102 may include, without limitation, a laptop, a desktop, a wearable device, a smart device, an artificial reality device, a personal digital assistant (PDA), etc. Additionally, or alternatively, computing device 102 may represent a backend computing device such as a server. Examples of servers may include, without limitation, application servers, database servers, and/or any other relevant type of server. Although illustrated as a single entity in FIG. 1, computing device 102 may include and/or represent a group of multiple servers that operate in conjunction with one another.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally, or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Set of musical compositions 110 may generally represent a set of one or more musical compositions composed by the same composer. In some examples, a musical composition may be a complete musical work such as a song. In other examples, a musical composition may be a partial musical work, such as a partially completed song (e.g., one or more verses, a chorus, one or more instrumental or vocal parts, etc.). In some embodiments, set of musical compositions 110 may represent a body of work uploaded by a composer to a streaming platform. Additionally, or alternatively, set of musical compositions 110 may include privately hosted files (e.g., on a composer's personal computing device).

The term “composition,” as used herein, may generally refer to any symbolic representation and/or any audio files of a piece of music and/or other piece of audio work (e.g., soundscape, soundtrack, etc.). In one example, a composition may be a piece of sheet music or representation of sheet music (e.g., via another type of notation, stored digitally, etc.). In another example, a composition may be a performance, recording of a performance (e.g., an audio file, video file, etc.), or representation of a performance. For example, in some embodiments, a live performance of a song and a studio recording of the same song by the same artist may be treated as separate compositions.

The term “composer,” as used herein, may generally refer to any person or entity who created and/or holds the legal rights to any part of a composition. For example, a composer may be someone who wrote the lyrics and/or music for a song. In another example, a composer may be a performer who performed a song and/or a band who performed a song. In one example, a composer may be a person or entity who has purchased the rights to perform, release, and/or modify a song.

Metadata 112 may generally represent any data describing or related to a musical composition that is not itself a musical composition. For example, metadata 112 may include listener preference data about one or more musical compositions. In some examples, metadata 112 may include listener activity, such as activity (e.g., heart rate, etc.) gathered from wearable devices worn by the listener. Additionally, or alternatively, metadata 112 may include data about requested modifications to a musical composition, such as instrumental or vocal parts, tempo, genre, etc.

ML model 114 may generally represent one or more ML models configured to take musical composition data as input and generate musical compositions as output. In some embodiments, ML model 114 may be a single generative ML model. In other embodiments, ML model 114 may include multiple ML models, such as including an analytical ML and music information retrieval model and a composition and generation ML model. In some embodiments, ML model 114 may include various types of models and/or networks such as a convolutional neural network, a generative adversarial network, and/or any other suitable type of neural network or other ML model.

New musical composition 116 may generally represent any type of musical work. In some examples, new musical composition 116 may be a complete musical work, such as a complete song. In other examples, new musical composition 116 may be part of a musical work, such as one or more verses or a chorus. In some embodiments, the systems described herein may output new musical composition 116 in multiple forms and/or formats. For example, the systems described herein may output new musical composition 116 in multiple file formats (e.g., multiple audio file formats). The term “audio file,” as used herein, may generally refer to any file containing audio information. For example, an audio file may be a playable file that includes a direct representation of audio data, such as an MP3 file, M4A file, WAV file, etc. In another example, an audio file may be a file that contains a symbolic representation of audio data, such as a MIDI file, a MusicXML file, etc. Additionally, or alternatively, the systems described herein may output multiple forms of new musical composition 116, some of which are portions of the new musical composition that are of a shorter duration than the new musical composition. For example, the systems described herein may output a complete song, a chorus of the song, a verse of the song, and/or a clip of the song of a predefined length (e.g., 30 seconds, 60 seconds, etc.).

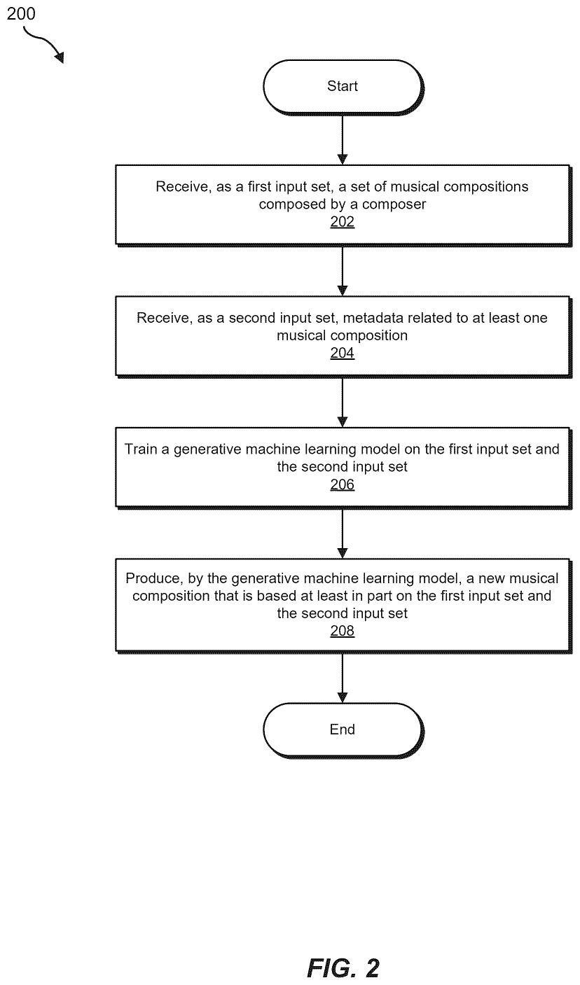

FIG. 2 is a flow diagram of an exemplary method 200 for algorithmic generation of musical compositions. In some examples, at step 202, the systems described herein may receive, as a first input set, a set of musical compositions composed by a composer.

In some examples, a user may upload a set of musical compositions to a music streaming platform. Alternatively, a user may have the systems described herein installed on a personal computing device and may input locally stored files. In one embodiment, a set of musical compositions may be stored on a server. In some examples, a user may supply a single musical composition, such as an unfinished song or a finished song. In other examples, a user may supply multiple musical compositions. In some embodiments, the systems described herein may receive additional training data, such as additional musical compositions (e.g., musical compositions in the public domain, licensed musical compositions, etc.). In other embodiments, the systems described herein may train an ML model solely on the musical compositions of a single composer without including training data from other composers. In some embodiments, the systems described herein may train an ML model with synthetic data. In one example, synthetic data may be data created artificially and/or algorithmically without ingesting existing musical compositions, thus rendering the data copyright-safe. In some examples, a model (e.g., a rule-based model, etc.) may initially be trained to create compositions without the ingestion of any existing musical works. In some embodiments, the systems described herein may augment an ML model's training data set with previously generated output from the ML model and/or other models (e.g., rule-based models). In some examples, synthetic training data may be generated via algorithms and rule-sets that are hand-written and/or curated by music data engineers.

The systems described herein may ingest, store, generate, and/or transmit data relating to musical compositions in a variety of formats. For example, the systems described herein may handle the data in any relevant audio format (e.g., MP3, WAV, etc.). Additionally, or alternatively, the systems described herein may handle the data in a symbolic format. In one embodiment, the systems described herein may use a proprietary data instruction format (serialized as a standard data format such as JavaScript Object Notation, Extensible Markup Language, etc.) that specifies these music production elements in a way that produces idempotent output.

At step 204, the systems described herein may receive, as a second input set, metadata related to at least one musical composition. The systems described herein may receive various types of metadata.

In some examples, the systems described herein may receive listener preference data. Listener preference data may include the frequency at which listeners of various demographics listen to specific songs or types of songs. For example, listener preference data may include tempos, genres, keys, instruments, moods, song structures, arrangements, song lengths, songwriting techniques and/or additional musical production elements that are preferred by listeners or that are otherwise correlated with improved song performance. In some embodiments, the systems described may gather the listener preference data by analyzing, via a music information retrieval model, the behavior of listeners in relation to the at least one musical composition. In some embodiments, the systems described herein may also analyze listener behavior in relation to additional musical compositions (e.g., by the composer of the musical composition and/or other composers). For example, the systems described herein may be part of a music streaming platform and may record the music selection behavior of listeners on the music streaming platform. Additionally, or alternatively, the systems described herein may import listener preference data from one or more third-party music streaming platforms.

In some embodiments, the systems described herein may receive data about the preferences of a specific listener in addition to or in place of group listener preference data. For example, the systems described herein may receive all of the above data about a specific listener, manually inputted preferences supplied by the listener (e.g., on a customization page of a music streaming platform, etc.), and/or data gathered by personal devices used by the listener (e.g., activity data from an app on a smart phone, heart rate data from a pulse sensor on a smart watch, etc.).

Additionally, or alternatively, the systems described herein may receive data about modifications to make to a song or other musical work. For example, the systems described herein may receive information about desired modifications to a genre, tempo, rhythms, mood, instrumentation, and/or other musical production elements of a song.

At step 206, the systems described herein may train a generative ML model on the first input set and the second input set. In some examples, the systems described herein may provide the first input set and the second input set to an already trained ML model to update the ML model. In other examples, the systems described herein may train an untrained ML model on the first input set and the second input set.

At step 208, the systems described herein may produce, by the generative ML model, a new musical composition that is based at least in part on the first input set and the second input set. For example, the generative ML model may produce a new song in the composer's style. Alternatively, the generative ML model may produce a new version of an existing song composed by the composer.

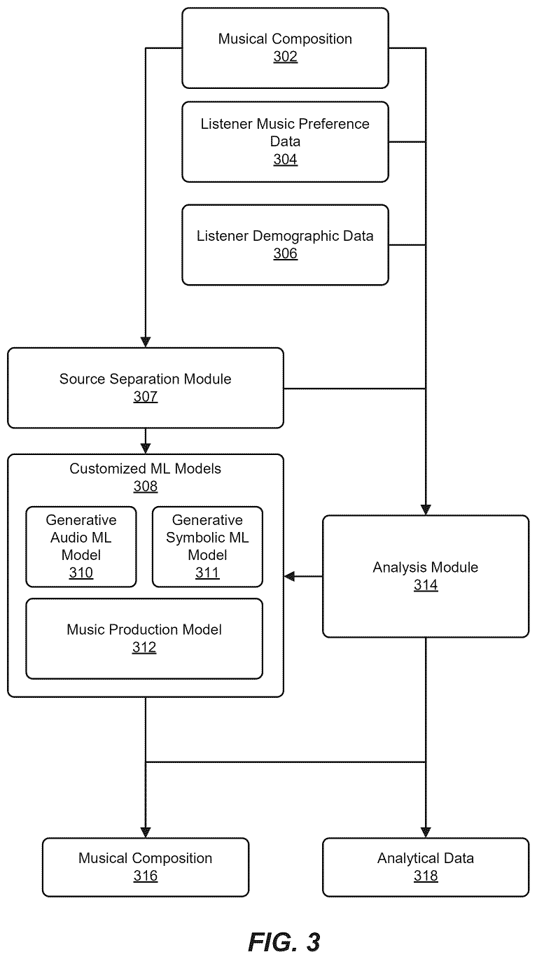

In some embodiments, the systems described herein may produce a new composition in a composer's style that is tailored to the preferences of one or more listeners on a streaming platform or other platform. For example, as illustrated in FIG. 3, a user may discover a musical compositions 302 on a music creation, composition, and/or streaming platform. In some examples, the platform may store listener music preference data 304. Additionally, or alternatively, the user may upload listener music preference data 304 (e.g., importing listening data from another platform, manually inputting preferences, etc.) in order to inform the generation of future works on the platform. In some examples, the platform and/or user may also provide listener demographic data 306 (e.g., geographic location, personal demographics, age, gender, other music listened to, etc.).

In some embodiments, the systems described herein may provide musical compositions 302, listener music preference data 304, and/or listener demographic data 306 as input to one or more customized ML models 308. In some examples, data may first pass through a source separation module 307.

Source separation module 307 may receive as input musical composition 302 and may use an ML-based source separation model to separate the input composition into a set of separate tracks such as drums, vocals, bass, etc. Source separation module 307 may pass a subset of the separated tracks to music production model 312 to be mixed into the modified composition. In some embodiments, music production model 312 may apply effects (e.g., audio effects such as reverb, etc.). In some examples, generative audio ML model 310 and/or generative symbolic ML model 311 may generate new tracks that replace another subset of the separated tracks. Additionally, or alternatively, generative audio ML model 310 and/or generative symbolic ML model 311 may generate new tracks that music production model 312 mixes with a third subset of tracks separated by source separation module 307. In some embodiments, the systems described herein may pass the separated tracks to analysis module 314 (together with music composition 302 and/or listener music preference data 304) to further inform the analysis process.

In some embodiments, analysis module 314 may receive as input the musical composition 302, the output of source separation module 307, listener music preference data 304, and/or listener demographic data 306. Analysis module 314 may use Music Information Retrieval (MIR) methods to extract musical information from musical composition 302 and from the tracks separated by source separation module 307, such as tempo, position of the beats, and/or chord progressions. Analysis module 314 may also use statistical methods to analyze the listener music preference data 304 and/or listener demographic data 306.

The systems described herein may map the result of this analysis into a set of generation parameters and provide those parameters as input to guide the output of the generative audio ML model 310 and/or generative symbolic ML model 311, as well as the output of the music production model 312. In some embodiments, the systems described herein may output a subset of the data resulting from the above-described analysis as analytical data 318.

In one embodiment, one or both of generative audio ML model 310 and/or generative symbolic ML model 311 may be a custom-trained deep neural network. In one example, the systems described herein may train generative audio ML model 311 directly on audio signals and generative audio ML model 311 may generate audio signals as output. In some examples, the systems described herein may train generative symbolic ML model 311 on a dataset of symbolic representations of music (e.g., similar to MIDI, etc.) and generative symbolic ML model 311 may generate symbolic output of the same kind that are rendered into audio signals as part of music production model 312.

In some examples, music production model 312 may receive as input a collection of original or newly generated tracks, together with a subset of the parameters generated by the analysis module 314. Music production model 312 may perform any or all of the following set of actions: applying a set of optional effects (such as time stretching, filtering, reverb, etc.) to the tracks, rendering the output of generative symbolic ML model 311 into audio signals, synchronizing all tracks, and/or mixing down all tracks with the appropriate mixing parameters to obtain the output musical composition 316.

The term “track,” as used herein, generally refers to any component of a musical composition that is produced by an instrument and/or the human voice. For example, a track may be the main vocals, the harmony, the guitar, the bass, and so forth. In some examples, a track may include audio produced by multiple instruments, such as the string section of an orchestra. In non-musical contexts, a track may be any isolatable section of an audio file, such as the wind, river noise, or thunder in an ambient soundscape.

In some embodiments, analysis module 314 that may produce analytical data 318 that includes inferences regarding listener preferences to inform future song generation, with the objective of improving song performance and/or listener engagement. These inferences may include, but are not limited to, tempos, genres, keys, instruments, moods, song structures, arrangements, song lengths, songwriting techniques and additional musical production elements that are preferred by listeners or that are otherwise correlated with improved song performance. Notably, given the demographic information of a particular composer's listener base, the systems described herein may extrapolate beyond the past works of any particular composer to make new suggestions to be incorporated into the composer's personalized compositional model (e.g., any or all of customized ML models 308) in order to improve song performance and/or listener engagement. For instance, the systems described herein may suggest new genres or musical styles that have not previously been produced by the composer, but that will likely appeal to the composer's listener base given their demographics. In some examples, the systems described herein may produce musical composition 316 based on musical composition 302 and analytical data 318 in order to appeal to listeners of the composer's previous works. Alternatively, the systems described herein may use analytical data 318 to create works that appeal to a specific listener. For example, the systems described herein may produce musical composition 316 to appeal to a specific listener of musical composition 302 based on that listener's personal preferences and/or current activity and/or mood. In some examples, the systems described herein may produce musical composition 316 in real time at the request of a listener while in other examples, the systems described herein may produce musical composition 316, store musical composition 316 on a server, and provide musical composition 316 to a listener at a later time.

In one embodiment, the systems described herein may create, at the request of a user, a finite number of “reversions” of a single, existing song, with all reversions including only those modifications approved by the composer. Reversions are derivative, or alternate, modified versions, of the original musical work that appropriately retain the core elements (e.g., melody, instrument, vocal, etc.) of said original music work. These new reversions-inclusive of changes in genre, tempo, rhythms, mood, instrumentation, and/or other musical production elements-may be surfaced to listeners depending on their unique preferences, thereby allowing our composers to engage new and different listeners. Other terms for creating a reversion may include, without limitation, song personalization, genre swapping, and/or style transfer. In some examples, the format of said reversions may include a collection of audio files that were created users in collaboration with analytical and generative machine learning and music information retrieval (MIR) models.

In one embodiment, the systems described herein may enable a user to request a reversion based on a function of the song. For example, the systems described herein may enable a user to request a song for working out, studying, sleeping, or other activities. In some examples, the systems described herein may automatically select a function based on current activity data about the user. For example, if a wearable device detects an elevated heartrate for the user, the systems described herein may create a reversion of a song for the function of working out. In one example, the systems described herein may match the beats per minute (BPM) of the reversion to the user's heart rate. In another example, if the user's personal computing device is executing an application related to studying (e.g., an academic learning application, a textbook reader, etc.), the systems described herein may generate a reversion of the song for the function of studying.

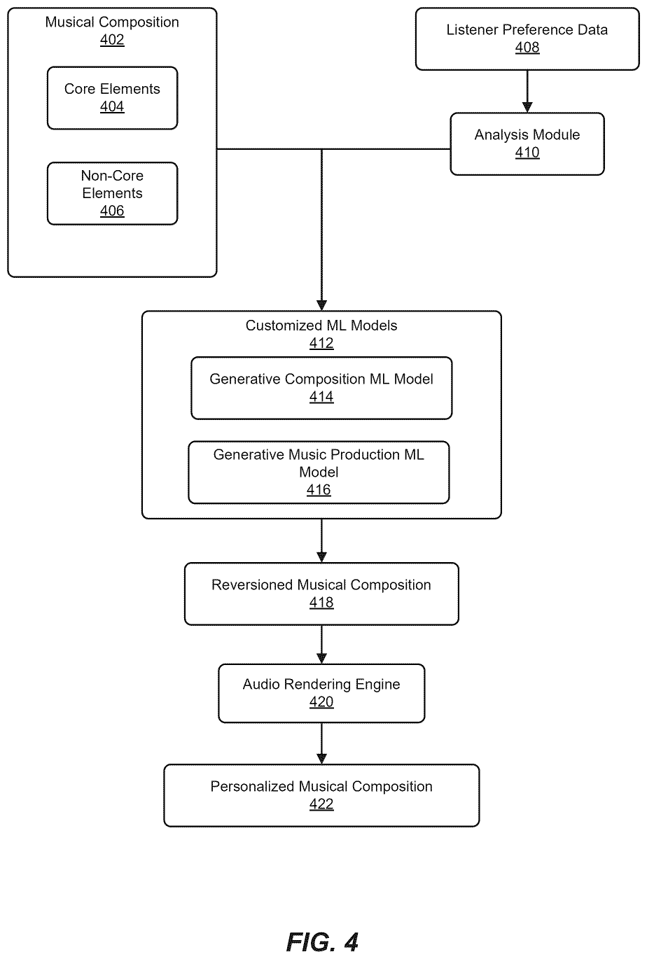

In some embodiments, as illustrated in FIG. 4, the systems described herein may enable the composer of a musical composition 402 to define core elements 404 that may not be modified and non-core elements 406 that may be modified. Examples of elements and modifications include, without limitation, compositional adjustments in song structure, overall duration, mood, beats per minute, key, harmonic progression(s), rhythmic patterns of non-melodic passages, changes to the instrument(s) and sound sources used in the recording, and/or music production changes that are reflected in the mix and mastering of resultant audio. By applying one or more of these modifications, the systems described herein may create reversioned musical works that may vary in genre, mood, and/or feel with the original musical work, but will still retain core elements 404. For example, a composer may specify that for a particular musical work, the topline vocal and accompanying lead guitar motif are core elements, making these elements ineligible for any modification and, in turn, constant across all future reversions. In another example, a composer may specify that the topline vocal, accompanying vocal, and key are core elements, but all other elements are not. The systems described herein may otherwise modify said musical work's other musical and auditory component(s) in the creation of future reversions that result in unique and personalized listening experiences for listeners.

In some embodiments, the systems described herein may enable the composer to specify limits within which non-core elements 406 may be modified. For example, the systems described herein may enable the composer to specify the range of non-original beats per minute (e.g., a minimum and/or maximum beats per minute) and/or which keys are suitable for the potential reversions of musical composition 402. In one embodiment, the systems described herein may retrieve listener preference data 408 and process listener preference data via an analysis module 410. The systems described herein may train customized ML models 412 that may include a generative composition ML model 414 and/or a generative music production ML model 416 to produce a reversioned musical composition 418 based on musical composition 402 that features a modification of at least one of non-core elements 406 based on listener preference data 408. In some embodiments, reversioned musical composition 418 may include raw audio data and the systems described herein may process reversioned musical composition 418 via an audio rendering engine 420 to create one or more playable audio files such as personalized musical composition 422.

In some embodiments, the systems described herein may include compositional models and corresponding audio rendering engine that allow for real-time personalization of songs according to a given listener's unique preferences. In one embodiment, the systems described herein may analyze a listener's preferences in existing playlists, genres, moods, etc. in order to inform the decision-making by a real-time generative compositional service that surfaces in real-time a reversioned work tailored to engage said listener. In some embodiments, the systems described herein may combine static, historical listener data with continuous, real-time data, such as heart rate supplied by wearable personal devices.

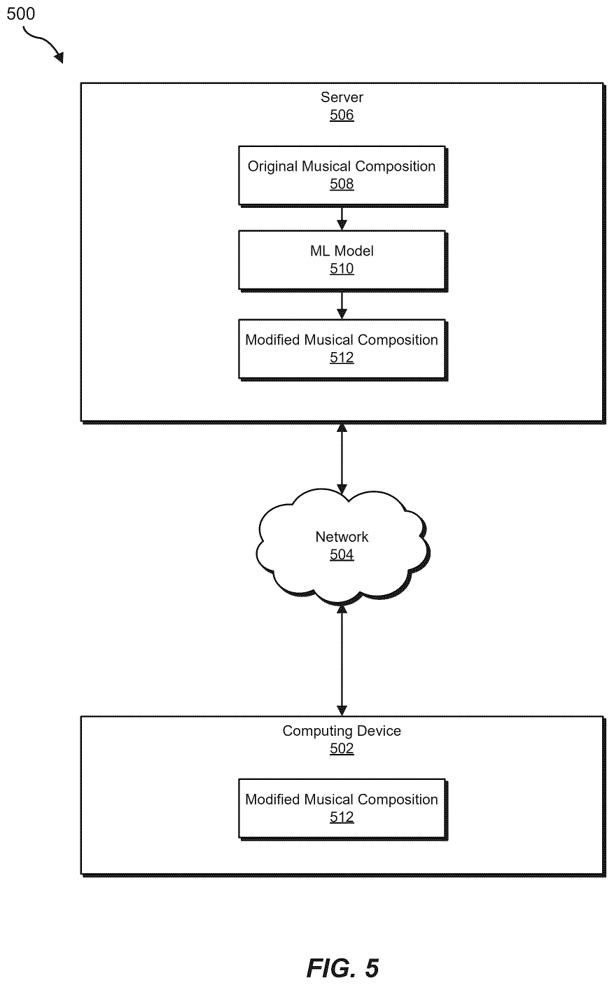

For example, as illustrated in FIG. 5, a user on a computing device 502 may, via a network 504, request a reversion of an original musical composition 508 that is stored on a server 506. In some examples, the reversion request may specify a modification, such as key, beats per minute, genre, etc. Additionally, or alternatively, the reversion request may indicate that the reversion should be based on listener preference data for the user. The systems described herein may receive this request and may, via an ML model 510, produce a modified musical composition 512. The systems described herein may transmit modified musical composition 512 to computing device 502 via network 504. In some embodiments, the systems described herein may include a music streaming platform hosted on server 506 and/or a website, application, or other interface for the music streaming platform displayed on computing device 502. In one example, the systems described herein may create modified musical composition 512 in real time while streaming modified musical composition 512 to the user.

As described above, the systems and methods described herein may facilitate the creation of novel musical works in a composer's own style by training customized ML models to create new musical compositions based on a composer's previous works and additional data, such as listener preference data and/or listener modification requests. In some embodiments, the systems described herein may facilitate the posting of musical works on social media by creating multiple forms and formats of a musical work, such as a clip of the chorus for a short-form social media platform and a file of the full song for a streaming platform.

### Example Embodiments

In some aspects, the techniques described herein relate to a computer-implemented method including: receiving a musical composition and listener preference data associated with at least one listener, extracting from the musical composition a first set of tracks and a second set of tracks, generating, by at least one generative machine learning model, based at least in part on the listener preference data, a new set of tracks, and combining, by a music production model, the first set of tracks extracted from the musical composition with the new set of tracks generated by the generative machine learning model to create a new musical composition based at least in part on the listener preference data.

In some aspects, the techniques described herein relate to a computer-implemented method, further including providing the new musical composition to the listener associated with the listener preference data.

In some aspects, the techniques described herein relate to a computer-implemented method, where: combining, by a music production model, the first set of tracks with the new set of tracks to create the new musical composition includes storing the new musical composition on a server, and providing the new musical composition to the listener includes: receiving a request from the listener, and retrieving the new musical composition from the server in response to the request.

In some aspects, the techniques described herein relate to a computer-implemented method, where: receiving the musical composition and the listener preference data associated with the at least one listener includes receiving a request from the listener to generate a novel musical composition, combining, by a music production model, the first set of with the new set of tracks to create the new musical composition includes creating the new musical composition in response to the request from the listener, and providing the new musical composition to the listener includes providing the new musical composition in real time in response to the request from the listener.

In some aspects, the techniques described herein relate to a computer-implemented method, where combining the first set of tracks with the new set of tracks to create the new musical composition includes excluding the second set of tracks from the new musical composition.

In some aspects, the techniques described herein relate to a computer-implemented method, where: extracting from the musical composition a first set of tracks and a second set of tracks includes extracting from the musical composition a third set of tracks, generating, by the at least one generative machine learning model, the new set of tracks includes modifying the third set of tracks based at least in part on the listener preference data, and combining the first set of tracks with the new set of tracks to create the new musical composition includes combining the modified third set of tracks with the first set of tracks and the new set of tracks to create the new musical composition.

In some aspects, the techniques described herein relate to a computer-implemented method, where combining, by the music production model, the first set of tracks with the new set of tracks to create the new musical composition includes synchronizing, by the music production model, the first set of tracks with the new set of tracks.

In some aspects, the techniques described herein relate to a computer-implemented method, where combining the first set of tracks with the new set of tracks to create the new musical composition includes applying, by the music production model, one or more audio effects to the new musical composition.

In some aspects, the techniques described herein relate to a computer-implemented method, where the at least one generative machine learning model includes a generative audio machine learning model that receives audio data as input and produces audio data as output.

In some aspects, the techniques described herein relate to a computer-implemented method, where the at least one generative machine learning model includes a generative symbolic machine learning model that receives symbolic data describing audio information as input and produces symbolic data describing audio information as output.

In some aspects, the techniques described herein relate to a computer-implemented method, where the at least one generative machine learning model includes at least two generative machine learning models including: a generative audio machine learning model that receives audio data as input and produces audio data as output, and a generative symbolic machine learning model that receives symbolic data describing audio information as input and produces symbolic data describing audio information as output.

In some aspects, the techniques described herein relate to a computer-implemented method, where the listener preference data includes a listening history of the listener.

In some aspects, the techniques described herein relate to a computer-implemented method, where the listener preference data includes an attribute of a desired musical composition selected by the user.

In some aspects, the techniques described herein relate to a computer-implemented method, where the attribute of the desired musical composition includes a genre of music.

In some aspects, the techniques described herein relate to a computer-implemented method, where the attribute of the desired musical composition includes a mood of the desired musical composition.

In some aspects, the techniques described herein relate to a computer-implemented method, where the attribute of the desired musical composition includes a function of the desired musical composition.

In some aspects, the techniques described herein relate to a computer-implemented method, where the listener preference data includes data on a current activity of the listener.

In some aspects, the techniques described herein relate to a computer-implemented method, where the data on the current activity of the listener is collected by a wearable computing device worn by the listener.

In some aspects, the techniques described herein relate to a system including: at least one physical processor, and physical memory including computer-executable instructions that, when executed by the physical processor, cause the physical processor to: receive a musical composition and listener preference data associated with at least one listener, extract from the musical composition a first set of tracks and a second set of tracks, generate, by at least one generative machine learning model, based at least in part on the listener preference data, a new set of tracks, and combine, by a music production model, the first set of tracks extracted from the musical composition with the new set of tracks generated by the generative machine learning model to create a new musical composition based at least in part on the listener preference data.

In some aspects, the techniques described herein relate to a non-transitory computer-readable medium including one or more computer-readable instructions that, when executed by at least one processor of a computing device, cause the computing device to: receive a musical composition and listener preference data associated with at least one listener, extract from the musical composition a first set of tracks and a second set of tracks, generate, by at least one generative machine learning model, based at least in part on the listener preference data, a new set of tracks, and combine, by a music production model, the first set of tracks extracted from the musical composition with the new set of tracks generated by the generative machine learning model to create a new musical composition based at least in part on the listener preference data.

In some aspects, the techniques described herein relate to a computer-implemented method including: receiving, as a first input set, a set of musical compositions composed by a composer; receiving, as a second input set, metadata related to at least one musical composition; training a generative machine learning model on the first input set and the second input set; and producing, by the generative machine learning model, a new musical composition that is based at least in part on the first input set and the second input set.

In some aspects, the techniques described herein relate to a computer-implemented method, where the metadata related to the at least one musical composition includes listener preference data about the at least one musical composition.

In some aspects, the techniques described herein relate to a computer-implemented method, further including gathering the listener preference data by analyzing, via a music information retrieval model, behavior of a plurality of listeners in relation to the at least one musical composition.

In some aspects, the techniques described herein relate to a computer-implemented method, where producing, by the generative machine learning model, the new musical composition includes tailoring, by the generative machine learning model, the new musical composition to appeal to listeners based on the listener preference data.

In some aspects, the techniques described herein relate to a computer-implemented method, where the listener preference data includes: behavior of a plurality of listeners in relation to the at least one musical composition; and behavior of the plurality of listeners in relation to additional musical compositions.

In some aspects, the techniques described herein relate to a computer-implemented method, where the at least one musical composition was composed by the composer.

In some aspects, the techniques described herein relate to a computer-implemented method, where producing, by the generative machine learning model, the new musical composition includes outputting the new musical composition in a plurality of different formats.

In some aspects, the techniques described herein relate to a computer-implemented method, where producing, by the generative machine learning model, the new musical composition includes: outputting the new musical composition as an audio file; selecting a portion of the new musical composition that is of a shorter duration than the new musical composition; and outputting the portion of the new musical composition as a second audio file.

In some aspects, the techniques described herein relate to a computer-implemented method, where producing, by the generative machine learning model, the new musical composition includes producing the new musical composition in real time while the new musical composition is being streamed to a listener.

In some aspects, the techniques described herein relate to a computer-implemented method, further including receiving, from a user, a specified modification for the new musical composition; and where producing, by the generative machine learning model, the new musical composition includes applying the specified modification to the new musical composition.

In some aspects, the techniques described herein relate to a computer-implemented method, where applying the specified modification to the new musical composition includes: comparing the specified modification to a list of allowed modifications input by the composer; and applying the specified modification in response to identifying the specified modification on the list of allowed modifications.

In some aspects, the techniques described herein relate to a system including: at least one physical processor; physical memory including computer-executable instructions that, when executed by the physical processor, cause the physical processor to: receive, as a first input set, a set of musical compositions composed by a composer; receive, as a second input set, metadata related to at least one musical composition; train a generative machine learning model on the first input set and the second input set; and produce, by the generative machine learning model, a new musical composition that is based at least in part on the first input set and the second input set.

In some aspects, the techniques described herein relate to a system, where the metadata related to the at least one musical composition includes listener preference data about the at least one musical composition.

In some aspects, the techniques described herein relate to a system, further including gathering the listener preference data by analyzing, via a music information retrieval model, behavior of a plurality of listeners in relation to the at least one musical composition.

In some aspects, the techniques described herein relate to a system, where producing, by the generative machine learning model, the new musical composition includes tailoring, by the generative machine learning model, the new musical composition to appeal to listeners based on the listener preference data.

In some aspects, the techniques described herein relate to a system, where the listener preference data includes behavior of a plurality of listeners in relation to the at least one musical composition; and behavior of the plurality of listeners in relation to additional musical compositions.

In some aspects, the techniques described herein relate to a system, where the at least one musical composition was composed by the composer.

In some aspects, the techniques described herein relate to a system, where producing, by the generative machine learning model, the new musical composition includes outputting the new musical composition in a plurality of different formats.

In some aspects, the techniques described herein relate to a system, where producing, by the generative machine learning model, the new musical composition includes: outputting the new musical composition as an audio file; selecting a portion of the new musical composition that is of a shorter duration than the new musical composition; and outputting the portion of the new musical composition as a second audio file.

In some aspects, the techniques described herein relate to a non-transitory computer-readable medium including one or more computer-readable instructions that, when executed by at least one processor of a computing device, cause the computing device to: receive, as a first input set, a set of musical compositions composed by a composer; receive, as a second input set, metadata related to at least one musical composition; train a generative machine learning model on the first input set and the second input set; and produce, by the generative machine learning model, a new musical composition that is based at least in part on the first input set and the second input set.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive music data to be transformed, transform the music data into training data for an ML algorithm, output a result of the transformation to generate music via a trained ML algorithm, use the result of the transformation to generate new musical compositions, and store the result of the transformation to provide the music to one or more streaming services. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving a musical composition and listener preference data associated with at least one listener;
extracting from the musical composition a first set of tracks and a second set of tracks;
generating, by at least one generative machine learning model, based at least in part on the listener preference data, a new set of tracks; and
combining, by a music production model, the first set of tracks extracted from the musical composition with the new set of tracks generated by the generative machine learning model to create a new musical composition based at least in part on the listener preference data.

2. The computer-implemented method of claim 1, further comprising providing the new musical composition to the listener associated with the listener preference data.

3. The computer-implemented method of claim 2, wherein:
combining, by a music production model, the first set of tracks with the new set of tracks to create the new musical composition comprises storing the new musical composition on a server; and
providing the new musical composition to the listener comprises:
receiving a request from the listener; and
retrieving the new musical composition from the server in response to the request.

4. The computer-implemented method of claim 2, wherein:
receiving the musical composition and the listener preference data associated with the at least one listener comprises receiving a request from the listener to generate a novel musical composition;
combining, by a music production model, the first set of with the new set of tracks to create the new musical composition comprises creating the new musical composition in response to the request from the listener; and
providing the new musical composition to the listener comprises providing the new musical composition in real time in response to the request from the listener.

5. The computer-implemented method of claim 1, wherein combining the first set of tracks with the new set of tracks to create the new musical composition comprises excluding the second set of tracks from the new musical composition.

6. The computer-implemented method of claim 1, wherein:
extracting from the musical composition a first set of tracks and a second set of tracks comprises extracting from the musical composition a third set of tracks;
generating, by the at least one generative machine learning model, the new set of tracks comprises modifying the third set of tracks based at least in part on the listener preference data; and
combining the first set of tracks with the new set of tracks to create the new musical composition comprises combining the modified third set of tracks with the first set of tracks and the new set of tracks to create the new musical composition.

7. The computer-implemented method of claim 1, wherein combining, by the music production model, the first set of tracks with the new set of tracks to create the new musical composition comprises synchronizing, by the music production model, the first set of tracks with the new set of tracks.

8. The computer-implemented method of claim 1, wherein combining the first set of tracks with the new set of tracks to create the new musical composition comprises applying, by the music production model, one or more audio effects to the new musical composition.

9. The computer-implemented method of claim 1, wherein the at least one generative machine learning model comprises a generative audio machine learning model that receives audio data as input and produces audio data as output.

10. The computer-implemented method of claim 1, wherein the at least one generative machine learning model comprises a generative symbolic machine learning model that receives symbolic data describing audio information as input and produces symbolic data describing audio information as output.

11. The computer-implemented method of claim 1, wherein the at least one generative machine learning model comprises at least two generative machine learning models comprising:
a generative audio machine learning model that receives audio data as input and produces audio data as output; and
a generative symbolic machine learning model that receives symbolic data describing audio information as input and produces symbolic data describing audio information as output.

12. The computer-implemented method of claim 1, wherein the listener preference data comprises a listening history of the listener.

13. The computer-implemented method of claim 1, wherein the listener preference data comprises an attribute of a desired musical composition selected by the user.

14. The computer-implemented method of claim 13, wherein the attribute of the desired musical composition comprises a genre of music.

15. The computer-implemented method of claim 13, wherein the attribute of the desired musical composition comprises a mood of the desired musical composition.

16. The computer-implemented method of claim 13, wherein the attribute of the desired musical composition comprises a function of the desired musical composition.

17. The computer-implemented method of claim 1, wherein the listener preference data comprises data on a current activity of the listener.

18. The computer-implemented method of claim 17, wherein the data on the current activity of the listener is collected by a wearable computing device worn by the listener.

19. A system comprising:
at least one physical processor; and
physical memory comprising computer-executable instructions that, when executed by the physical processor, cause the physical processor to:
receive a musical composition and listener preference data associated with at least one listener;
extract from the musical composition a first set of tracks and a second set of tracks;
generate, by at least one generative machine learning model, based at least in part on the listener preference data, a new set of tracks; and
combine, by a music production model, the first set of tracks extracted from the musical composition with the new set of tracks generated by the generative machine learning model to create a new musical composition based at least in part on the listener preference data.

20. A non-transitory computer-readable medium comprising one or more computer-readable instructions that, when executed by at least one processor of a computing device, cause the computing device to:
receive a musical composition and listener preference data associated with at least one listener;
extract from the musical composition a first set of tracks and a second set of tracks;
generate, by at least one generative machine learning model, based at least in part on the listener preference data, a new set of tracks; and
combine, by a music production model, the first set of tracks extracted from the musical composition with the new set of tracks generated by the generative machine learning model to create a new musical composition based at least in part on the listener preference data.
